(19) United States
(12) Patent Application Publication
(10) Pub. No.: US 2008/0162261 A1
(43) Pub. Date: Jul. 3, 2008

(54) VIRTUAL REALITY SYSTEM INCLUDING PERSONALIZED VIRTUAL ENVIRONMENTS

(76) Inventors: Herb F. Velazquez, Neenah, WI (US); Rebecca S. Walter, Hortonville, WI (US); Matthew K. Gruttadauria, Yarmouthport, MA (US); Todd J. Huelskamp, Milford, MA (US); Daniel P. Gara, Appleton, WI (US); William M. Lynch, Greenville, WI (US); Cheryl A. Perkins, Appleton, WI (US)

Correspondence Address: PATTERSON & SHERIDAN, L.L.P.;ATTN: GERO G. MCCLELLAN / KIMBERLY-CLARK, 3040 POST OAK BLVD., SUITE 1500, HOUSTON, TX, 77056, US

(21) Appl. No.: 11/618,764

(22) Filed: Dec. 30, 2006

(51) Int. Cl. G06F 17/00

(52) U.S. Cl. 705/10

(57) ABSTRACT

Embodiments of the invention include methods, apparatus and articles of manufacture for generating and using virtual reality simulations to conduct market research and related activities, where the virtual reality simulations include personalized aspects of a participant's environment, such as simulations of a virtual home derived from the participant's physical home. In this way, aspects of product design such as product storage and product use can be simulated.

### BACKGROUND OF THE INVENTION

1. Field of the Invention

Embodiments of the present invention generally relate to virtual reality simulations, and more particularly to virtual reality simulations generated using computer software, where the virtual reality simulation provides a personalized virtual environment.

2. Description of the Related Art

The manufacture and marketing of consumer products is highly competitive, and product manufacturers spend enormous sums of money on product and product packaging design. Virtual reality tools have been developed to assist in visualizing real spaces. For example, virtual shopping tools are available to simulate consumer activity and to conduct market research based on consumer interaction with computer simulations representing a shopping environment and to allow for market research based on consumer interaction with computer-generated representation of a shopping environment.

However, the virtual reality applications developed or published to date have tended to focus on consumer purchase decisions. For example, several computer-assisted simulation and virtual reality tools have been developed to represent shopping experiences simulating products on shelves of a retail store. Such a simulation may be configured to allow a participant to select a product, and the focus of market research has been on factors that may influence a consumer's purchase selection decision. Market research conducted using these methods have proven useful in exploring purchase decisions and the effects of shelf layout or package appearance on consumer behavior.

Although important, the point of purchase decision is only a single aspect of product and product packaging design and use considered by product manufacturers. For example, another important source of information occurs after a purchase decision. Specifically, the experience a user has when opening the package and using the product in their home environment can have a significant impact on future purchasing decisions.

Once a product has been opened, removed from any packaging, and used for its intended purpose, the home environment of a given consumer may have a significant influence on whether that consumer views a product as performing well. Currently, however, few approaches exist for obtaining market research data from consumers related to product and packaging performance in environments where consumers actually use the product. One approach to obtain market research data in this context has been to conduct a reach study where study participants are provided with detailed questionnaires seeking to characterize consumers experience with a given product. These consumer research studies are notoriously inadequate. First, it is difficult, if not outright impossible to know in advance which questions need to be asked. Thus, the questionnaires tend to include a voluminous number of questions. Unfortunately, relevant details often get lost in the minutiae of this approach. Second, even when participants give what they believe to be an accurate response, often people interact with a product in ways they do not realize, making it difficult, if not impossible for an individual to convey some information about their experience with a product in a questionnaire. A second approach involves observing a group of participants in their homes interacting with a product being evaluated. However, besides the obvious intrusiveness of this approach, it is also cost prohibitive in many cases.

Accordingly, to improve the optimization of products and marketing approaches, there remains a need for an end-to-end approach in which allows rapid assimilation of information from consumers and sharing this information with both retail sellers and product manufactures and designers.

### SUMMARY OF THE INVENTION

Embodiments of the invention provide virtual reality tools used to conduct market research and related activity, including a virtual reality tools for including a virtual home, or other personalized virtual environment, in a virtual reality simulation.

One embodiment of the invention provides a computer-assisted method of conducting market research using a virtual reality simulation. The method includes generating a personalized virtual reality simulation based on a first data collection and a second data collection. The first data collection describes a physical living space of a virtual reality simulation participant and the second data collection describes product information regarding a product to be evaluated. The personalized virtual reality simulation simulates the living space of the simulation participant. The method also includes presenting the virtual reality simulation to the simulation participant and monitoring the simulation participant interacting with the product to be evaluated and the virtual reality simulation.

Another embodiment of the invention includes a computer-readable storage medium containing a program configured to generate a virtual reality simulation used to facilitate market research. The program includes instructions for performing operations of generating a personalized virtual reality simulation based on a first data collection and a second data collection, where the first data collection describes a physical living space of a virtual reality simulation participant and the second data collection describes product information regarding a product to be evaluated, and where the personalized virtual reality simulation simulates the living space of the simulation participant. The operations of the program further include presenting the virtual reality simulation to the simulation participant and monitoring the simulation participant interacting with the product to be evaluated and the virtual reality simulation.

Another embodiment of the invention provides a computer-assisted method for an individual to conduct market research or product design using a virtual reality simulation. The method includes specifying a first collection of attributes to include in the virtual reality simulation, where the first collection of attributes describe elements of a product to be evaluated, and also includes specifying a second collection of attributes to include in the virtual reality simulation, where the second collection of attributes describe a living space used to personalize the virtual reality simulation. The method also includes generating the virtual reality simulation simulating an intended use of the product is to occur within the living space, and presenting the virtual reality simulation to the individual using a virtual reality display platform.

Another embodiment of the invention includes a computer-readable storage medium containing a program configured to generate a virtual reality simulation used to facilitate market research. The program includes instructions for receiving a first collection of attributes to include in the virtual reality simulation, where the first collection of attributes describe elements of a product to be evaluated, and instructions for receiving a second collection of attributes to include in the virtual reality simulation, where the second collection of attributes describe a living space used to personalize the virtual reality simulation. The program also include instructions for generating the virtual reality simulation simulating an intended use of the product is to occur within the living space and presenting the virtual reality simulation to the individual using a virtual reality display platform.

Another embodiment of the invention includes a system comprising a computing device and a memory storing a virtual reality tool. The virtual reality tool is configured to generate a personalized virtual reality simulation based on a first data collection and a second data collection, where the first data collection describes a physical living space of a virtual reality simulation participant and the second data collection describes product information regarding a product to be evaluated. The personalized virtual reality simulation simulates the living space of the simulation participant. The virtual realty tool is further configured to present the virtual reality simulation to the simulation participant and monitor the simulation participant interacting with the product to be evaluated.

Another embodiment of the invention provides a computer-assisted method of conducting market research using a virtual reality simulation. The method generally includes generating a personalized virtual reality simulation based on a first data collection and a second data collection, where the first data collection describes at least one personal item associated with a virtual reality simulation participant, and where second data collection describes product information regarding a product to be evaluated. The virtual reality simulation is personalized using the first data collection and generated using at least the first and second data collection. The method also includes presenting the virtual reality simulation to the simulation participant and monitoring the simulation participant interacting with the product to be evaluated and the virtual reality simulation.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual illustration of a computing environment and virtual reality system configured to generate simulations of a virtual home, according to one embodiment of the invention.

FIG. 2 is a conceptual diagram further illustrating components of the virtual reality system first shown in FIG. 1, according to one embodiment of the invention.

FIG. 3 is a flow chart illustrating a method for generating a virtual reality simulation that includes a virtual home for a participant in a market research study to interact with, according to one embodiment of the invention.

FIG. 4 is a flow chart illustrating a method for generating a virtual reality simulation including a virtual home to use in product design and/or evaluation, according to one embodiment of the invention.

### DETAILED DESCRIPTION

Embodiments of the invention include methods, apparatus and articles of manufacture for generating and using virtual reality simulations to conduct market research and related activities. In one embodiment, the simulation includes a personalized aspect with respect to a simulation participant. For example, the virtual reality simulations can include simulations of a virtual instance of the simulation participant's actual home or living space. By extending virtual reality simulations beyond a conventional simulation of a consumer purchase decision, aspects of product design such as product packaging, product storage and product use can be simulated and then evaluated more effectively and more thoroughly than is possible using present systems.

In one embodiment, a virtual reality simulation may extend or integrate a simulation of merchandising and consumer shopping behavior, such as the placement of a product on a store shelf, with other aspects of product use. For example, market researchers or product designers may observe a simulation participant interacting with an actual or simulated version of the product within a personalized virtual environment. In particular, the personalized virtual environment may represent the actual living space of the simulation participant. By creating simulations for a large group of such participants, market research may be rapidly conducted efficiently and effectively, without the time, expense, or intrusiveness of observing the participants in their respective living spaces. At the same time, by creating a personalized virtual environment for each simulation participant, the quality of market research may be significantly improved. Further, as product design is frequently an iterative process, changes made to product design after one round of virtual reality simulations may be shown in subsequent rounds much more rapidly than is possible using conventional product design methodologies.

In an alternative embodiment, a virtual reality system may be used to provide market researchers or product designers with virtual simulations of a product being used in a variety of consumer home environments. For example, a virtual reality system may have access to a database of multiple homes. The database of virtual homes may be used to provide rapid access to details of product placement, appearance, use and storage using a variety of typical (or atypical) virtual home scenarios. For example, a selection of virtual homes may cut across different aspects of a target market audience including simulations of product use within small urban apartments, large homes, dorm rooms, single family homes, and other living spaces. As used herein, the term or “home” and “virtual home” should be read to include these and other individual living spaces. The simulations of virtual homes may also be tailored to simulate virtual homes representative of different geographical or national regions. Doing so may allow a product designer or market researcher to overcome institutional or cultural biases when evaluating or developing a given product design. The database of virtual homes may be used to generate multiple simulations, used by market researchers, designers, etc., to assist in product marketing design, promotions, etc., and the simulations may be provided to various relevant parties, as needed, such as marketers packaging designers, retail customers, category developers, etc.

The input data used to create a virtual reality simulation of that includes a virtual home may be obtained from a variety of sources. For example, simulation participants may provide information related to their home directly, including the provision of photographs, CAD drawings, architectural plans, etc., or a participant may interact with the virtual reality environment to create a personalized virtual home representative of their actual home. By including multiple simulation participants, large market research studies may be performed where the virtual reality simulation is personalized to reflect the actual living space of each participant. Alternatively, virtual homes may be generated based on a set of input parameters specifying aspects of a living space to simulate. Such input parameters include, for example, square footage, interior design choices, presence (or absence) of occupants, pets, etc, ambient sound, smells, lighting, etc. Another possible alternative includes generating virtual home environments based on feedback provided by consumers that describes their living spaces and experiences with a given product. Of course, embodiments of the invention do not require any particular methodology or techniques for generating the database of virtual homes.

Further, the following description references embodiments of the invention. However, it should be understood that the invention is not limited to any specifically described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media on which information is permanently stored (e.g., read-only memory devices within a computer such as CD-ROM or DVD-ROM disks readable by a CD-ROM or DVD-ROM drive); (ii) writable storage media on which alterable information is stored (e.g., floppy disks within a diskette drive, hard-disk drives, or flash memory devices). Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

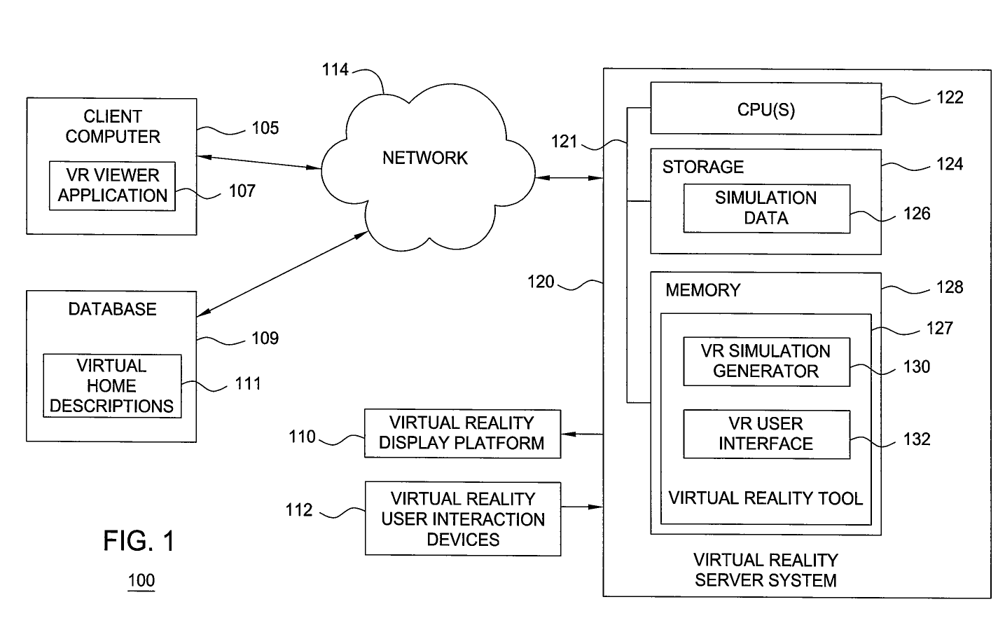

FIG. 1 is a conceptual illustration of a computing environment 100 and virtual reality system 120 configured to generate simulations of a virtual home used in market research, according to one embodiment of the invention. As shown, computing environment 100 includes a client computer system 105 and a database system 109 in communication with the virtual reality server system 120 over a network 114. The computer systems 105, 109, and 120 illustrated in environment 100 are included to be representative of existing computer systems, e.g., desktop computers, server computers, laptop computers, tablet computers and the like. However, embodiments of the invention are not limited to any particular computing system, application, device, or network architecture and instead, may be adapted to take advantage of new computing systems and platforms as they become available. Additionally, those skilled in the art will recognize that the illustration of computer systems 105, 109, and 120 are simplified to highlight aspects of the present invention and that computing systems and networks typically include a variety of elements not shown in FIG. 1.

As shown, server system 120 includes one or more CPUs 122, storage 124, and memory 128 connected by a bus 121. CPU 122 is a programmable logic device that executes the instructions, logic and mathematical processing performed in executing user applications (e.g., a virtual reality tool 127). Storage 124 stores application programs and data for use by server system 120. Common storage devices 124 include hard-disk drives, flash memory devices, optical media and the like. Network 114 represents any kind of data communications network, including both wired and wireless networks. Accordingly, network 114 is representative of both local and wide area networks, including the Internet.

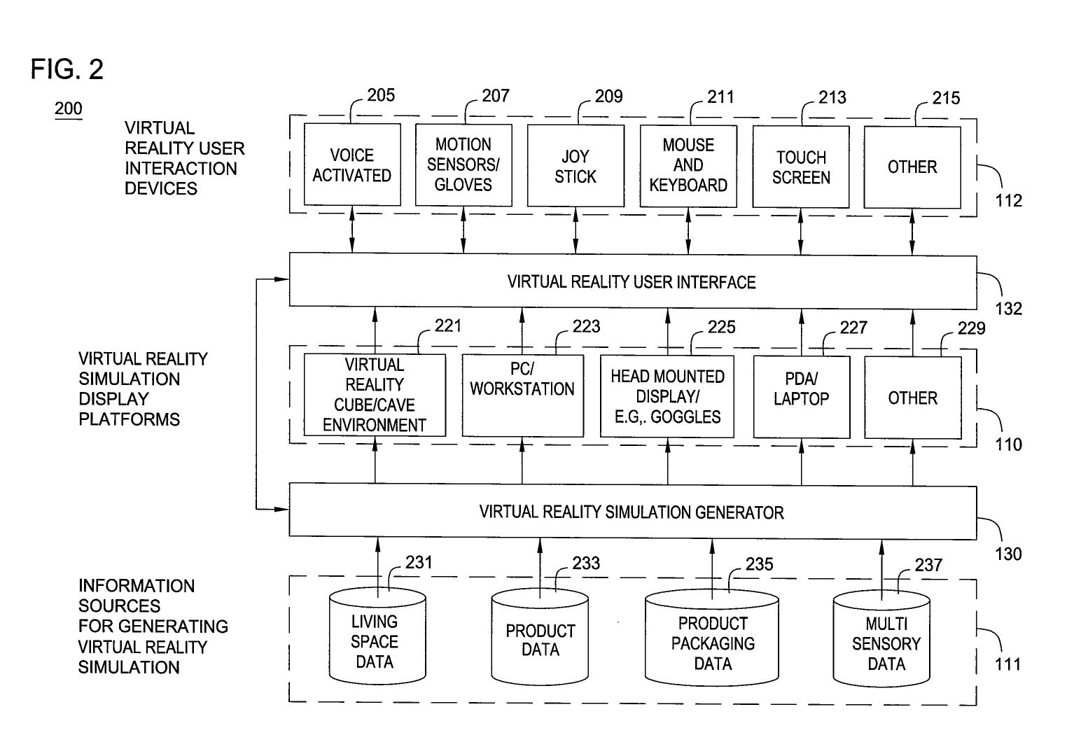

In one embodiment, relevant individuals may access and view a simulation that includes a virtual home generated by server system 120 using client computer system 105 and a viewing application 107. For example, virtual reality tool 127 may be configured to generate a simulation that may be viewed over network 114 using viewing application 107. For example, viewing application 107 may be a web-browser configured to display multi-media content such as audio and video streams. Alternatively, relevant individuals may view and interact with a virtual reality simulation using a variety of virtual reality display platforms 110 and user interaction devices 112 communicating with server system 120. Examples of display platforms 110 and user interaction devices 112 are described below in conjunction with a description of FIG. 2. Additionally, the processing activity of server system 120 may be coordinated by an operating system (not shown). Well known examples of operating systems include the Windows® operating system, distributions of the Linux® operating system, among others.

Database 109 may include a collection of one or more virtual home descriptions 111. The virtual home descriptions 111 may correspond to actual living spaces of simulation participants and/or may include a collection of virtual homes representative of different consumers, market segments, geographic locales, and the like. Thus, database 109 may be used to store virtual home descriptions 11 that represent a variety of local, national, or global market segments or demographics. Doing so allows market researches and retail sellers to gain information about how products may be used, stored, and displayed in the living spaces of a target market for a given project. As stated, the virtual homes descriptions 111 available in database 109 may be used to provide rapid access to details of product placement, appearance, use and storage using a variety of typical (or atypical) virtual home scenarios.

In one embodiment, database 109 and virtual reality system 127 may be integrated with a virtual reality system for presenting retail environments. Doing so may allow relevant parties (e.g., market researchers, product designers, retail sellers, etc.) to track a simulation participant beginning with the shopping experience all the way through to opening a product, removing the product from its packaging, and using the product in a virtual home environment. Thus, product developers, marketers, and researchers can evaluate the total end-to-end performance of a product, including evaluating aspects of product use and packaging performance in a virtual home. Market researchers, designers, and other relevant individuals may observe such actions or receive summaries about participants' behavior and interaction with a product. Thus, embodiments of the invention may allow these parties to readily identify opportunities and/or problems with a given product and/or packaging design, especially in relation to the performance of the product and/or packaging design in different virtual home environments.

Illustratively, memory 128 of server system 120 includes reality tool 127. Virtual reality tool 127 may be a software application that allows users to generate and display a virtual reality simulation that includes a virtual home, where the simulation is configured using simulation data 126. For example, a simulation participant may provide information related to their living space and this information may be used to generate a personalized virtual reality simulation for that participant. In one embodiment, a participant may be provided with a graphical user interface allowing her to specify various aspects of her home to approximate the layout of her actual home. In such a case, the participant may specify, aspects of a living space generated as part of a simulation, such as home square footage, interior design choices, presence (or absence) of occupants, pets, etc, ambient sound, smells, lighting, among others.

Simulation data 126 may also include any information used to specify elements of a virtual environment to be generated. For example, simulation data 126 may include information related to a product being evaluated, the participant, the participant's home, etc. As shown, virtual reality tool 127 includes a simulation generator 130 and a virtual reality user interface 132. User interface 132 provides an interface to configure and use virtual reality tool 127, including allowing a simulation participant to interact with a virtual realty simulation generated using generator 130.

Simulation generator 130 may be configured to generate a simulation from simulation data 126 that may be presented to relevant individual or individuals. In one embodiment, the virtual reality simulation may be presented to a market researcher, product designer, product manufacturer, to present a simulation of the product as used in a given home environment. Alternatively, the virtual reality simulation may be presented to a simulation participant who interacts with the simulation while being observed and/or recorded for the purpose of performing market research.

FIG. 2 is a conceptual diagram further illustrating components of the virtual reality system first shown in FIG. 1, according to one embodiment of the invention. More specifically, FIG. 2 illustrates an exemplary collection of virtual reality display platforms 110, user interaction devices 112, and simulation data 126 used to generate and present a virtual reality simulation that includes a virtual home. Interaction devices 112 may allow a simulation participant to interact with elements of the virtual reality simulation. As shown, interaction devices 112 may include a voice activated system 205, motion sensing devices 207 worn by a user, e.g., a set of motion sensing gloves or goggles, a joystick device 209, a mouse and keyboard device 211, a touch screen device 213, or other user interface device 215. Of course, depending on how a virtual reality simulation is presented to a simulation participant, the particular input devices 112 may be tailored to suit the needs in an individual case.

In various embodiments, different virtual reality display platforms may used to present a simulation participant or observer with a virtual reality simulation of a product, as it is used in a virtual home. As stated, the virtual home may be a virtual space personalized for a simulation participant, or the virtual home may be generated from a configurable set of simulation parameters to represent a particular market segment or demographic, or selected from a collection of virtual home descriptions 111 stored in database 109.

Motion sensing gloves (and other motion tracing devices) may record the movements of a participant during a simulation. For example, sensors worn by the participant could record hand, arm, leg, body and/or head movements of the participant. Subsequently, the recorded movements may be used to generate representation of the participant in a video sequence for review by a market researcher or product designer. Such a sequence may provide a view of the simulation either through the eyes of the participant or from other camera angles focused on the participant. Additionally, the movement recorded by motion sensing devices may be included as represented in a video sequence generated from the simulation. For example, trace lines showing paths of movement made by the participant through the 3D space of the simulation may be used. Trace lines may provide a visual indication of the movements at the level of motion provided by a finger, hand, or person. Such information may be useful for, among other things to show time, steps, or effort required for a user to interact with a given product.

Similarly, eye tracking movement device 215 may be configured to record where a simulation participant is looking over the course of a virtual reality simulation. As is known, a laser device may be used to monitor the movements of the retinas of a simulation participant. These movements may be used to set a position for a virtual camera when a representation of the simulation generated for review by a market researcher or product designer. Such a representation may provide a real-time, or time adjusted video sequence showing what the simulation participant was looking at during the virtual reality simulation. That is, the video sequence provides a view of the simulation through the eyes of the simulation participant. Of course, depending on how a virtual reality simulation is presented to a simulation participant, the particular input devices 112 may be tailored to suit the needs in an individual case.

Illustratively, virtual reality display platforms include a virtual reality cube/sphere or “CAVE Automatic Virtual Environment” (CAVE) environment 221, a PC workstation 223 and LCD or CRT monitor, a head-mounted display 225 worn by a viewer or simulation participant, a PDA or laptop computer 227 or other user virtual reality display platform 229. As is known, a CAVE environment provides immersive virtual environment where a user may interact with a virtual reality system inside a room where projectors are directed to, e.g., three, four, five or six of the walls of a cube. The images may be in stereo requiring stereo shutter glasses to be worn. Presenting a simulation participant with a simulation using virtual reality cube 221 may provide the participant with a fully immersive visualization where the screens of the CAVE/CUBE present an interactive virtual home environment where the participant's entire visual (and possibly other sensory experiences) is provided by the virtual reality cube 221. Similarly, a head mounted display 225, such as a virtual reality helmet or 3D goggles may provide an immersive virtual environment for presenting a virtual reality simulation of a virtual home. In such cases, the virtual reality simulation presented to the simulation participant may be personalized to provide a simulation based on that participant's actual home. Additional examples of a virtual reality simulations that include the sue of a head mounted display are described in application Ser. No. 10/435,413, filed May 9, 2003 titled “Vision System and Method for Observing Use of a Product by a Consumer,” incorporated by reference herein in its entirety.

In another embodiment, a virtual reality simulation of a virtual home may be displayed on a monitor of PC workstation 223 or on a display screen of a PDA or laptop 227. Of course, embodiments of the invention are not limited to these virtual reality display platforms, and may be adapted for use with other existing platforms as well as new ones that become available. As stated, virtual reality simulation generator 130 may be configured to generate a simulation presented on one or more of display platforms 110 based on specified simulation data 126. FIG. 2 illustrates a number of exemplary data sources that may be used to specify simulation data 126 for a given virtual reality simulation. As shown, simulation data may include living space data 231, product data 233, product packaging data 235, and multi-sensory data 237.

Living space data 231 may describe a particular home environment for use with a virtual reality simulation. For example, static photographs of products in a participant's home may be combined with real (or simulated) video footage to show details of product use within the virtual home environment. Thus, a single virtual home may be created from CAD drawings or architectural drawings of an actual home. Similarly, living space data 231 may include photographs of the product as it was used in the participant's home. To provide this information, in one embodiment, a virtual reality simulation may be generated from data obtained while the participant interacts with the product in their actual living space. For example, photographs or video footage of the participant actually using a product in their home may be obtained. In a particular embodiment, the Consumer Vision System described in the '413 application may be used to obtain clips from participants directly as they interact with a product, either before or after their participation in a virtual shopping exercise, or may be adapted from clips obtained from similar consumers in similar homes. Such information could show, for example, differences in how a mother used a wet-wipe product and other related products when changing a bay on the carpet of her home, on a changing table, in a bathroom or on a bed or couch. All such information may produce different insights regarding how well wet-wipe product or product packaging is designed.

Product data 233 includes any data related to the product being evaluated and/or simulated for a virtual reality simulation. For example, product data 233 may include the product itself, product features, product packaging, and the like. More specifically, product data 233 may specify aspects of a product such as product design, materials, aesthetics, ergonomic aspects, colors, shapes, scents, textures, sounds, user perceptions of usefulness and/or performance, price, branding, perceptions of value, package count, package design, purchase intent, sensory perceptions, among others, to use in generating a virtual reality simulation. Similarly, product packaging data 235 may be used to specify aspects of product packaging to include in a virtual reality simulation. For example, packaging data 235 may specify aspects of packaging performance, such as the opening of a package, the removal of a product from a package, the reusability of a package, and/or the disposal characteristics of a package, to name but a few. Thus, embodiments of the invention provide for a virtual reality simulation that simulates aspects of product use and storage, including simulation a consumer's experiences in storing a product, opening a package containing a product, removing the product from a package, preparing and using the product, and disposing of the product and/or packaging. In other words, a total end-to-end simulation of consumer experience with a product is provided, including consumer experience with the product in the virtual home environment.

In one embodiment, the presence of the products being evaluated in the virtual home may be added to the virtual reality simulation by taking photographs of the actual placement of a product in the home used by the participant, such as photographs of where a consumer placed the product in their home, (e.g., on a countertop or placed under a sink). Further, the use of such information may be dynamic, for example, a virtual reality simulation may be modified to, to simulate how a change in the product or product packing might change how a consumer or simulation participant might interact with the product in their home.

In addition to data 231, 233, and 235, in one embodiment, a virtual reality simulation may be augmented using multi-sensory data 237. In various embodiments, in addition to visual aspects of a virtual reality simulation, a multi-sensory simulation may be generated. A multi-sensory simulation may combine sights, sounds, tactile responses, or even tastes to personalize the virtual reality environment for the simulation participant. For example, a package of cleaning wipes may be virtually represented such that a simulation participant interacting with a virtual home environment can open the virtual package and hear the sound of the product as the packaging is opened. Taking this example one step further, such a participant may also be exposed to a scent characteristic of the product as part of the simulation. If the simulation were the use of a cleaning product in the participants' home, the simulation may also include scents associated with the home such as the smells of a diaper pail. In such a case, the scents of both the home and the cleaning product may interact, allowing the participant to observe the effectiveness of the cleaning product within the virtual environment. Including a variety of aspects of the simulated product performance such as, sounds, smells, and actions resulting from a participants' interaction with a virtual product may improve the quality of a virtual reality simulation.

Any of these sensory components may be simulated, as part of a virtual reality simulation. For example, instrumented gloves 207 and other devices in contact with a simulation participant may be used to simulate representations of weight texture, resilience, warmth, coolness. In one embodiment, scents may be delivered to the display platform 110 to simulate scent characteristics of the product as it is opened or used. Imagery and sounds may be reproduced in both two-dimensional and three-dimensional versions of a virtual reality simulation of product use within a home. Further, multi-sensory aspects of a virtual reality simulation may be tailored to reflect how a simulation participant actually interacts with the product during the simulation. For example, in opening a package, a rapid motion may result in the simulation display platform playing a higher frequency sound than if a slow motion is used to open the package. As another example, agitating the virtual product may result in a greater amount of a product's scent characteristic to be released into the virtual reality environment.

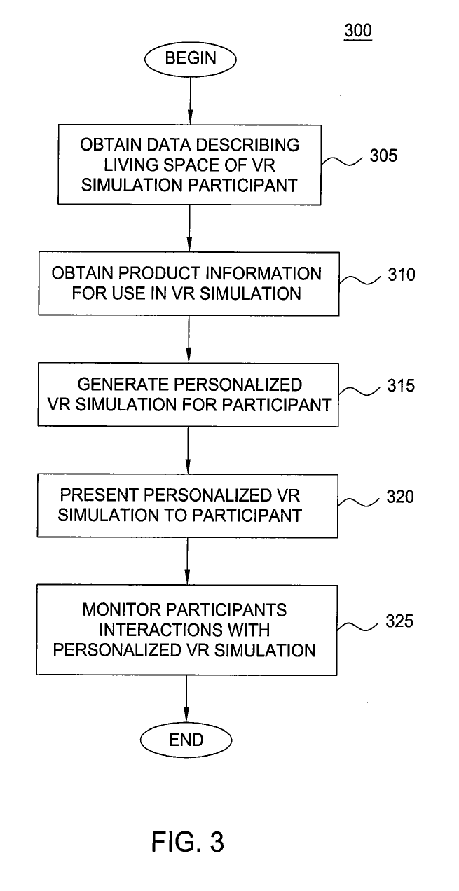

FIG. 3 is a flow chart illustrating a method 300 for generating a virtual reality simulation that includes a virtual home for a participant in a market research study to interact with, according to one embodiment of the invention.

As shown, the method 300 begins at step 305, where data describing the living space of a virtual reality simulation participant is obtained. For example, as described above, a participant may provide actual photographs or drawings of their home, or may respond to an interactive questionnaire to describe elements of the participant's home. At step 310, product information for use in the virtual reality simulation is obtained. As described above, product information may include information related to the product itself, as well as information related to aspects of the product packaging. Further, such information may include multi-sensory data used to create the virtual reality simulation.

At step 315, using the input data obtained at steps 305 and 310, a personalized virtual reality simulation is generated for the simulation participant. And at step 320, the virtual reality simulation generated at step 315 may be presented to the participant. Once “active” the participant may intact with the product in the personalized virtual reality environment in any of the ways described above. At step 325, while the participant interacts with the simulation, a market researcher, product designer, retailer, or manufacturer (among others) may observe the participant as she interacts with the virtual environment provided by the virtual reality simulation. Alternately, the participant's interactions may be monitored by the virtual reality display platform and stored for subsequent review.

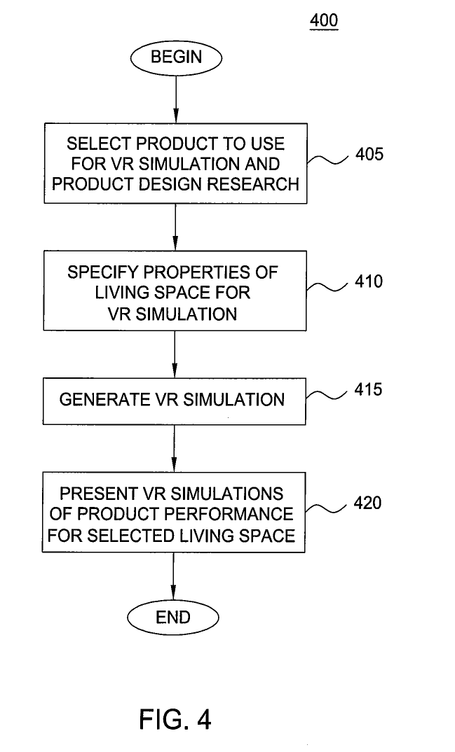

FIG. 4 is a flow chart illustrating a method 400 for generating a virtual reality simulation including a virtual home to use in product design and/or evaluation, according to one embodiment of the invention. In one embodiment, a market researcher, product designer, retailer, or manufacturer may perform the method 400 to create, view, and interact with a virtual reality simulation that simulates how a consumer may interact with a given product within a particular home environment. As shown, the method 400 begins at step 405 where a product to use in the virtual reality simulation is selected. In one embodiment, the product itself, as well as aspects of product packaging, design and parameters of product performance (e.g., scents or other multi-sensory elements of the product) may be specified. At step 410, properties of the living space for the virtual reality simulation may be specified. In the exemplary embodiments described above, living space properties may be obtained based on data provided by consumers about their actual homes, based on representative descriptions of living spaces for different market segments, or based on a database of home descriptions.

At step 415, a virtual reality simulation may be generated based on the input data selected at steps 405 and 410. And at step 420, the virtual reality simulation generated at step 415 may be presented to the participant. Once “active” the researcher may interact with the product in the personalized virtual reality environment in any of the ways described above. Additionally, such a simulation may be stored and shared among different individuals collaborating on a product or packaging design.

As described herein, embodiments of the invention may be used to create virtual reality simulations used for market research and related activities, where the virtual reality simulations include simulations of a virtual home. By extending virtual reality simulations beyond a conventional simulation of a consumer purchase decision, aspects of product design such as product storage and product use can be simulated and then evaluated more effectively and more thoroughly than is possible using present systems. Advantageously, by generating a virtual reality simulation that includes personalized aspects, such as virtual home environments, representative of actual home environments, product designers and manufacturers may better optimize products and marketing approaches, without incurring the large expense of conducting “field-based” market research in many homes.

While the foregoing is directed to embodiments of the present invention, other and further embodiments of the invention may be devised without departing from the basic scope thereof, and the scope thereof is determined by the claims that follow.

What is claimed is:

1. A computer-assisted method of conducting market research using a virtual reality simulation, comprising;
generating a personalized virtual reality simulation based on a first data collection and a second data collection, wherein the first data collection describes a physical living space of a virtual reality simulation participant and the second data collection describes product information regarding a product to be evaluated, and wherein the personalized virtual reality simulation simulates the living space of the simulation participant;
presenting the virtual reality simulation to the simulation participant; and
monitoring the simulation participant interacting with the product to be evaluated and the virtual reality simulation.

2. The method of claim 1, wherein the first data collection includes at least one of photographs, CAD drawings, video footage and architectural plans of the living space of the simulation participant.

3. The method of claim 1, wherein the living space of the virtual reality simulation participant comprises at least one of an apartment, a condominium, a single family home, a duplex, a triplex, an n-plex, a dormitory, a rest home, or an assisted living facility.

4. The method of claim 1, wherein receiving the first data collection comprises, prompting the simulation participant to specify attributes of the living space, and receiving responses form the simulation participant.

5. The method of claim 1, wherein the product information includes aspects of product packaging, and wherein the virtual reality simulation allows the simulation participant to simulate at least one of opening a package containing a product, removing the product from the product packaging, preparing to use the product, using the product, and disposing of the product or disposing of the product packaging.

6. The method of claim 1, wherein the product information includes multi-sensory information that describes at least one of a scent characteristic of the product, a sound characteristic of the product, a scent characteristic of product packaging or a sound characteristic of product packaging.

7. The method of claim 1, wherein the product information includes aspects of the product to be evaluated including at least one of product design, product materials, colors, shapes, scents, textures sounds, of the product to be evaluated.

8. The method of claim 1, wherein the virtual reality simulation is presented to the simulation participant using an immersive virtual reality environment.

9. The method of claim 8 wherein the immersive virtual reality environment is a virtual reality cube.

10. A computer-readable storage medium containing a program configured to generate a virtual reality simulation used to facilitate market research, the program including instructions for performing an operation, comprising:
generating a personalized virtual reality simulation based on a first data collection and a second data collection, wherein the first data collection describes a physical living space of a virtual reality simulation participant and the second data collection describes product information regarding a product to be evaluated, and wherein the personalized virtual reality simulation simulates the living space of the simulation participant;
presenting the virtual reality simulation to the simulation participant; and
monitoring the simulation participant interacting with the product to be evaluated and the virtual reality simulation.

11. The computer-readable medium of claim 8, wherein the first data collection includes at least one of photographs, CAD drawings, video footage and architectural plans of the living space of the simulation participant.

12. The computer-readable medium of claim 8, wherein the living space of the virtual reality simulation participant comprises one of an apartment, a condominium, a single family home, a duplex, a triplex, an n-plex, a dormitory, a rest home, or an assisted living facility.

13. The computer-readable medium of claim 8, wherein receiving the first data collection comprises, prompting the simulation participant to specify attributes of the living space, and receiving responses form the simulation participant.

14. The computer-readable medium of claim 8, wherein the product information includes aspects of product packaging, and wherein the virtual reality simulation allows the simulation participant to simulate at least one of opening a package containing a product, removing the product from the product packaging, preparing to use the product, using the product, and disposing of the product or disposing of the product packaging.

15. The computer-readable medium of claim 8, wherein the product information includes multi-sensory information that describes at least one of a scent characteristic of the product, a sound characteristic of the product, a scent characteristic of product packaging or a sound characteristic of product packaging.

16. The computer-readable medium of claim 8, wherein the product information includes aspects of the product to be evaluated including at least one of product design, product materials, colors, shapes, scents, textures sounds, of the product to be evaluated.

17. The computer-readable medium of claim 1, wherein the virtual reality simulation is presented to the simulation participant using an immersive virtual reality environment.

18. The computer-readable medium of claim 17, wherein the immersive virtual reality environment is a virtual reality cube.

19. A computer-assisted method for an individual to conduct market research or product design using a virtual reality simulation, comprising:
specifying a first collection of attributes to include in the virtual reality simulation, wherein the first collection of attributes describe elements of a product to be evaluated;
specifying a second collection of attributes to include in the virtual reality simulation, wherein the second collection of attributes describe a living space used to personalize the virtual reality simulation;
generating the virtual reality simulation simulating an intended use of the product is to occur within the living space; and
presenting the virtual reality simulation to the individual using a virtual reality display platform.

20. The method of claim 19, wherein the display platform provides an immersive virtual reality environment used to present the individual with the virtual reality simulation.

21. The method of claim 19, wherein the second collection of attributes includes at least one of photographs, CAD drawings, video footage and architectural plans of to use in generating virtual reality simulation.

22. The method of claim 19, wherein the first collection of attributes includes aspects of product packaging regarding the product to be evaluated, and wherein the virtual reality simulation presents the individual with a simulation of at least one of opening a package containing the product, removing the product from the product packaging, preparing to use the product, using the product, and disposing of the product or disposing of the product packaging.

23. The method of claim 19, wherein the product information includes multi-sensory information that describes at least one of a scent characteristic of the product, a sound characteristic of the product, a scent characteristic of product packaging, or a sound characteristic of product packaging.

24. A computer-readable storage medium containing a program configured to generate a virtual reality simulation used to facilitate market research, the program including instructions for performing an operation, comprising:
receiving a first collection of attributes to include in the virtual reality simulation, wherein the first collection of attributes describe elements of a product to be evaluated;
receiving a second collection of attributes to include in the virtual reality simulation, wherein the second collection of attributes describe a living space used to personalize the virtual reality simulation;
generating the virtual reality simulation simulating an intended use of the product is to occur within the living space; and
presenting the virtual reality simulation to the individual using a virtual reality display platform.

25. The computer-readable medium of claim 24, wherein the display platform provides an immersive virtual reality environment used to present the individual with the virtual reality simulation.

26. The computer-readable medium of claim 24, wherein the second collection of attributes includes at least one of photographs, CAD drawings, video footage and architectural plans of to use in generating virtual reality simulation.

27. The computer-readable medium of claim 24, wherein the first collection of attributes includes aspects of product packaging regarding the product to be evaluated, and wherein the virtual reality simulation presents the individual with a simulation of at least one of opening a package containing the product, removing the product from the product packaging, preparing to use the product, using the product, and disposing of the product or disposing of the product packaging.

28. The computer-readable medium of claim 24, wherein the product information includes multi-sensory information that describes at least one of a scent characteristic of the product, a sound characteristic of the product, a scent characteristic of product packaging, or a sound characteristic of product packaging.

29. A system, comprising:
a computing device; and
a memory storing a virtual reality tool, wherein the virtual reality tool is configured to:
generate a personalized virtual reality simulation based on a first data collection and a second data collection, wherein the first data collection describes a physical living space of a virtual reality simulation participant and the second data collection describes product information regarding a product to be evaluated, and wherein the personalized virtual reality simulation simulates the living space of the simulation participant,
present the virtual reality simulation to the simulation participant, and
monitor the simulation participant interacting with the product to be evaluated.

30. The system of claim 29, wherein the product information includes aspects of product packaging, and wherein the virtual reality simulation allows the simulation participant to simulate at least one of opening a package containing a product, removing the product from the product packaging, preparing to use the product, using the product, and disposing of the product or disposing of the product packaging.

31. A computer-assisted method of conducting market research using a virtual reality simulation, comprising;
generating a personalized virtual reality simulation based on a first data collection and a second data collection, wherein the first data collection describes at least one personal item associated with a virtual reality simulation participant and the second data collection describes product information regarding a product to be evaluated, wherein the virtual reality simulation is personalized using the first data collection and the second data collection;
presenting the virtual reality simulation to the simulation participant; and
monitoring the simulation participant interacting with the product to be evaluated.

32. The method of claim 31, wherein the second data collection includes aspects of product packaging regarding the product to be evaluated, and wherein the virtual reality simulation allows the simulation participant to simulate at least one of opening a package containing a product, removing the product from the product packaging, preparing to use the product, using the product, or disposing of the product packaging.
